(19) United States
(12) Patent Application Publication
(10) Pub. No.: US 2016/0103558 A1
(43) Pub. Date: Apr. 14, 2016

(54) PROJECTIVE TOUCH APPARATUS

(71) Applicant: Wistron Corporation, New Taipei City (TW)

(72) Inventors: Chia-Chang Hou, New Taipei City (TW); Po-Liang Huang, New Taipei City (TW); Chia-Jui Liu, New Taipei City (TW)

(21) Appl. No.: 14/586,965

(22) Filed: Dec. 31, 2014

(30) Foreign Application Priority Data
Oct. 9, 2014 (TW) 103218058

(51) Int. Cl. G06F 3/042; H04N 9/31

(52) U.S. Cl. CPC G06F 3/0421; H04N 9/3141

(57) ABSTRACT

A projective touch apparatus includes a rail base, a plate standing vertically on the rail base, an optical touch module, a platform slidably disposed through a rail structure of the rail base, a projector, and a host. The optical touch module is disposed on the plate for positioning a touch position of a touch object on a touch surface of the plate. The projector is disposed on the platform and located under the plate, to move with sliding of the platform to a projecting position for projecting an image to the touch surface or a back surface of the plate, or to a containing position to be contained on the rail base. The host is disposed in the rail base for controlling the projector to project the image and for performing a touch operation of the touch object on the touch surface according to the touch position and the image.

### BACKGROUND OF THE INVENTION

1. Field of the Invention

The present invention relates to a projective touch apparatus, and more specifically, to a projective touch apparatus disposing a projector on a rail base to be located under a plate.

2. Description of the Prior Art

In general, a conventional projective touch apparatus utilizes a projector, which is located above a projection plate (e.g. a whiteboard) via a hanging arm extending forwardly from a top side of the projection plate for projecting images to the projection plate, and an optical touch module disposed on a projection plate to allow that a user could use a touch object (e.g. a stylus) to perform touch operations (e.g. selecting a function icon or moving a cursor) on the projection plate according to the images projected by the projector.

However, since the aforesaid design causes the projector to shake easily when the user uses the touch object to perform touch operations on the projection plate due to excessive mounting height of the projector, the image shaking problem may occur accordingly so as to influence the touch accuracy of the projective touch apparatus and the viewing comfort of the images projected by the projector. Furthermore, the aforesaid design may also make the projective touch apparatus have an excessive volume so as to cause the user much inconvenience in setting up and moving the projective touch apparatus.

### SUMMARY OF THE INVENTION

The present invention provides a projective touch apparatus including a rail base, a plate, an optical touch module, a platform, a projector, and a host. The rail base has a rail structure. The plate stands vertically on the rail base and has a touch surface and a back surface opposite to the touch surface. The optical touch module is disposed on the plate for positioning a touch position of at least one touch object on the touch surface. The platform is slidably disposed through the rail structure. The projector is disposed on the platform and located under the plate for moving with sliding of the platform along the rail structure to a projecting position to project an image to the touch surface or a back surface of the plate, or to a containing position to be contained on the rail base. The host is disposed in the rail base and electrically connected to the projector and the optical touch module for controlling the projector to project the image and for performing a touch operation of the at least one touch object on the touch surface according to the touch position of the at least one touch object and the image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a front view of a projective touch apparatus according to an embodiment of the present invention.

FIG. 2 is a side view of the projective touch apparatus in FIG.

FIG. 3 is a diagram of an optical touch module in FIG. 2 being disposed on a plate.

FIG. 4 is a side view of a projector in FIG. 2 moving to a containing position with sliding of a platform.

### DETAILED DESCRIPTION

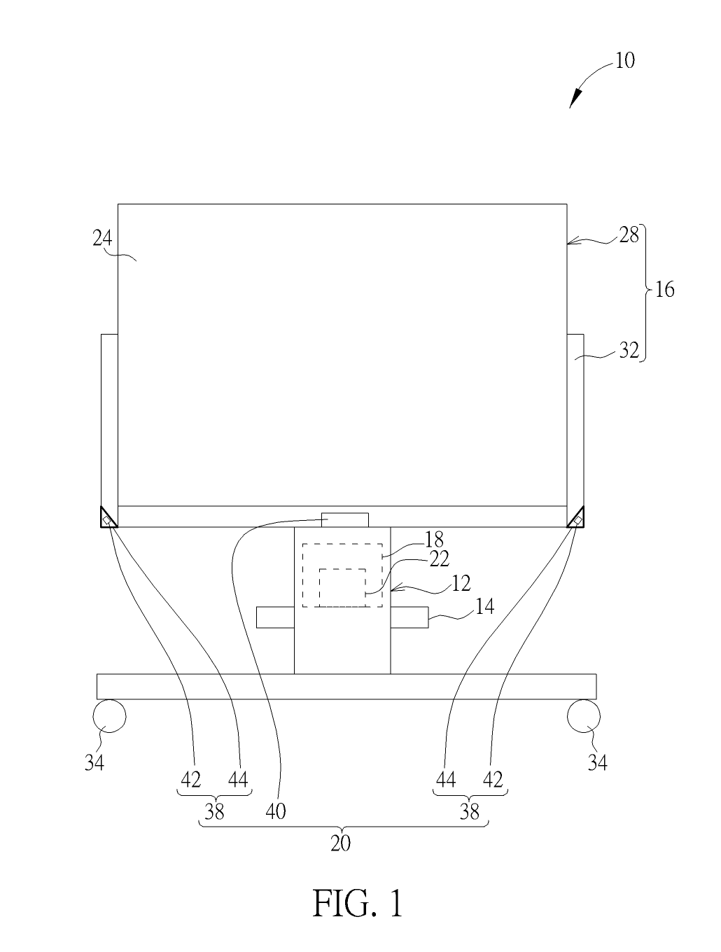

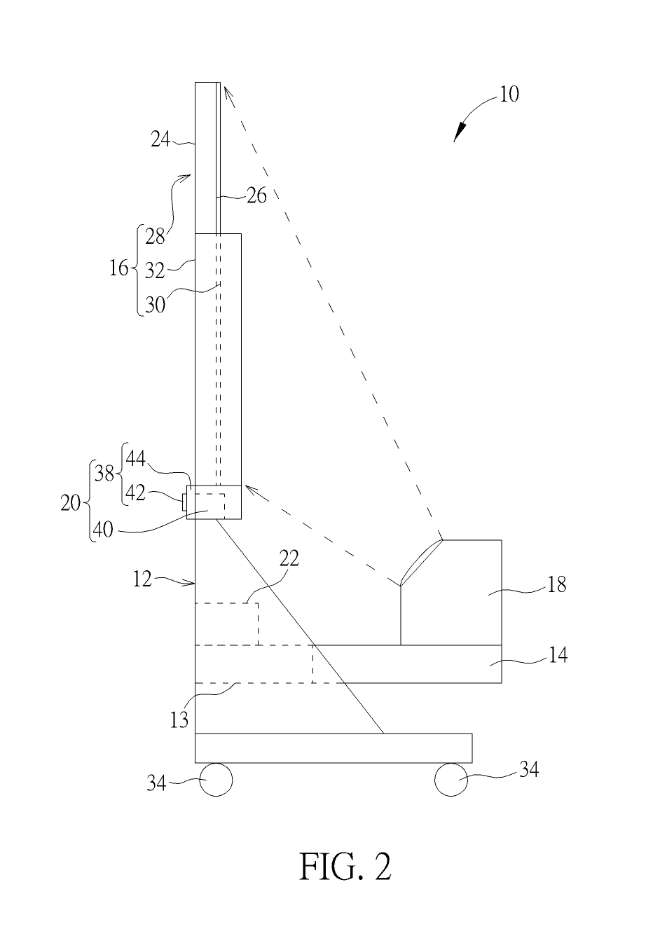

Please refer to FIG. 1 and FIG. 2. FIG. 1 is a front view of a projective touch apparatus 10 according to an embodiment of the present invention. FIG. 2 is a side view of the projective touch apparatus 10 in FIG. 1. As shown in FIG. 1 and FIG. 2, the projective touch apparatus 10 includes a rail base 12, a platform 14, a plate 16, a projector 18, an optical touch module 20, and a host 22. The rail base 12 has a rail structure 13 (briefly depicted by dotted lines in FIG. 2). The platform 14 is slidably disposed through the rail structure 13, so as to make the platform 14 slidable relative to the rail base 12. The rail base 12 could adopt a sectional sliding design so that a user could pull or push the platform 14 step by step for adjusting a projecting position of the projector 18, or could adopt a stepless sliding design so that the user could perform a stepless position adjustment of the projector 18 according to the practical projecting condition for directly moving the projector 18 to an appropriate projecting position.

The plate 16 stands vertically on the rail base 12 and has a touch surface 24 and a back surface 26 opposite to the touch surface 24. The projector 18 could be preferably a short-throw projector (but not limited thereto) for shortening an overall length of the projective touch apparatus 10. The projector 18 is disposed on the platform 14 and located under the plate 16. To be more specific, in this embodiment, the projective touch apparatus 10 could preferably adopt a rear projection design for image projection, meaning that the projector 18 could be located behind the plate 16 for projecting images in a rear projection manner. For example, the plate 16 could have a transparent plate portion 28 and a projection film 30. The projection film 30 is attached on the back surface 26 of the transparent plate portion 28. Accordingly, when the projector 18 moves with sliding of the platform 14 along the rail structure 13 to a projecting position as shown in FIG. 2 so as to be located behind the plate 16, the projector 18 could project images to the projection film 30 for displaying images through the transparent plate portion 28. In such a manner, since the aforesaid design does not hamper the user's movement in front of the plate 16, it could further improve operational convenience of the projective touch apparatus 10.

In practical application, the transparent plate portion 28 could be preferably made of transparent tempered glass material, and the plate 16 could further have a support frame portion 32 disposed around the transparent plate portion 28 and fixed to the rail base 12 so as to make the transparent plate portion 28 disposed on the rail base 12 more steadily. In such a manner, due to high distortion resistance and high hardness of the aforesaid glass material, the present invention could further enhance the structural strength of the plate 16 without additional reinforcement ribs (e.g. metal ribs), so that the present invention could efficiently solve the prior art problem that a plate made of wood material could be scratched and broken easily due to external factors (e.g. sudden impact or high environment moisture) and could further reduce the overall weight of the plate 16. Furthermore, the projective touch apparatus 10 could further include a plurality of wheel 34. The plurality of wheel 34 is disposed under the rail base 12 for further increasing mobility of the projective touch apparatus 10, so that the user could push the projective touch apparatus 10 to go forward or backward in any direction to a set-up position.

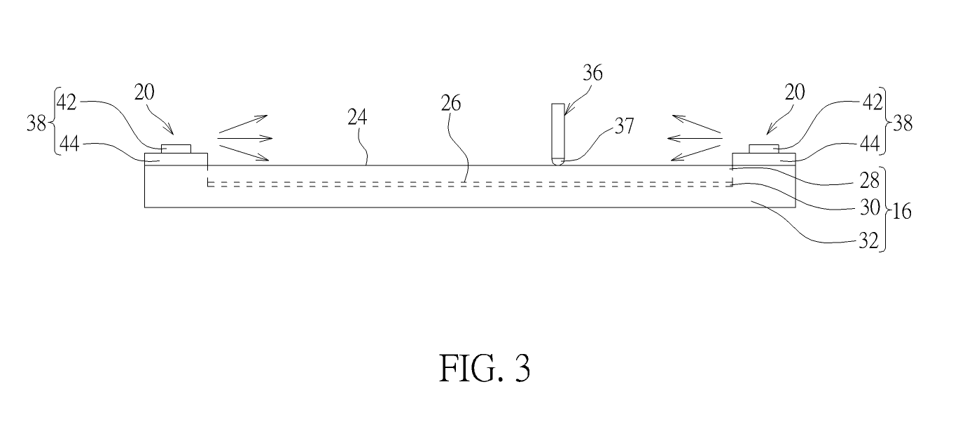

As for description for the designs of the optical touch module 20 and the host 22, it could be as shown in FIG. 2 and FIG. 3. FIG. 3 is a diagram of the optical touch module 20 in FIG. 2 being disposed on the plate 16. In this embodiment, the optical touch module 20 is disposed on the support frame portion 32. The optical touch module 20 could preferably adopt a reflection image capturing method for positioning a touch position of a touch object on the touch surface 24 according to trigonometric functions, but not limited thereto, meaning that the optical touch module 20 could also adopt other optical touch methods (e.g. a light interruption method). For example, as shown in FIG. 2 and FIG. 3, the user could use at least one touch object 36 (one shown in FIG. 3, but not limited thereto) to perform touch operations on the touch surface 24. The touch object 36 could be preferably a stylus and have a reflection end portion 37 (e.g. a reflection layer made of micro glass beads). The optical touch module 20 could include at least two optical devices 38 (two shown in FIG. 3, but not limited thereto) and a circuit board 40. The host 22 could be a conventional computer host. The host 22 could be disposed in the rail base 12 and electrically connected to the projector 18 and the optical touch module 20. Each optical device 38 could include a light emitting unit 42 and an image capturing unit 44. The light emitting unit 42 could be preferably an infrared light emitting diode (but not limited thereto) for emitting light toward the touch surface 24. The image capturing unit 44 (e.g. an infrared camera) could be disposed at a position corresponding to a corner of the touch surface 24 and located under the light emitting unit 42 for capturing touch images toward the touch surface 24. The circuit board 40 is electrically connected to the optical device 38 and the host 22 for controlling operations of the optical device 38 (e.g. an image capturing operation or a light emitting operation). The circuit board 40 is further used for positioning (e.g. via calculation based on trigonometric functions) a touch position of the touch object 36 on the touch surface 24 according to a reflection position of the reflection end portion 37 in the touch images captured by each image capturing unit 44. The host 22 is used for controlling the projector 18 to project images and performing the touch operations (e.g. selecting a function icon or moving a cursor) of the touch object 36 on the touch surface 24 according to the images projected by the projector 18 and the touch position of the touch object 24.

To be noted, mounting number of the optical device 38 and number of the touch object 36 that the user could use on the touch surface 24 are not limited the aforesaid embodiment. That is, the number of the touch object 36 that the user could use on the touch surface 24 could vary with the mounting number of the optical device 38. For example, in an embodiment in which there are two optical devices 38 disposed on the plate 16, the user could use at most two touch objects 36 to perform a multi-touch operation on the touch surface 24. In another embodiment, if the optical touch module 20 adopts the design in which there are four optical devices 38 disposed at positions corresponding to four corners of the touch surface 24 respectively, the user could use at most four touch objects 36 to perform a multi-touch operation on the touch surface 24 since the optical touch module 20 could position touch positions of the four touch objects 36 on the touch surface 24 at one time.

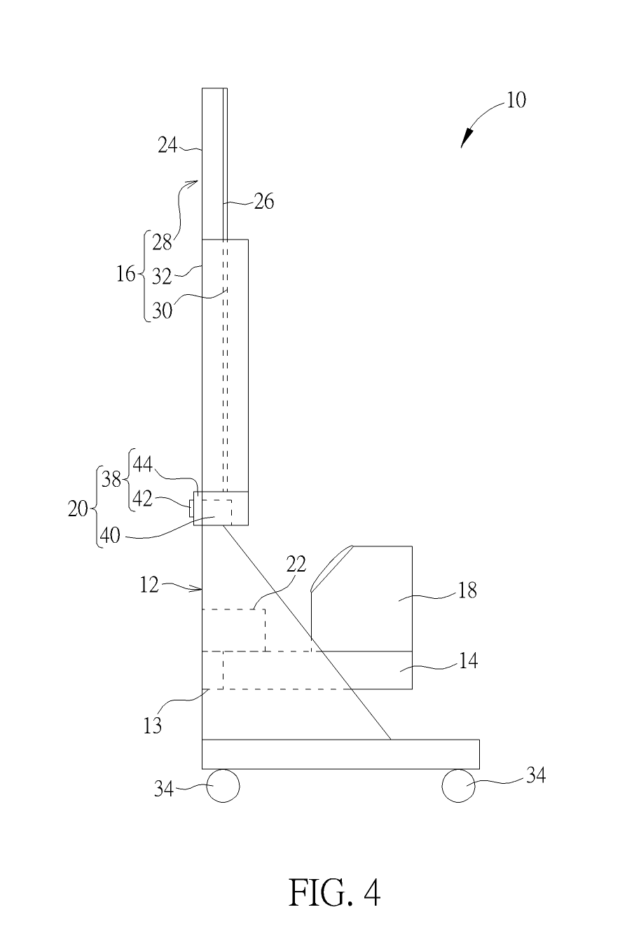

More detailed description for the projective touch operation and the projector containing operation of the projective touch apparatus 10 is provided as follows. Please refer to FIG. 2 and FIG. 4. FIG. 4 is a side view of the projector 18 in FIG. 2 moving to a containing position with sliding of the platform 14. When the user wants to use the projective touch apparatus 10 to perform a projective touch operation, the user just needs to pull the platform 14 to slide outwardly along the rail structure 13 relative to the rail base 12 until the projector 18 moves to the projecting position as shown in FIG. 2 with sliding of the platform 14. Subsequently, the host 22 could control the projector 18 to project images to the projection film 30 attached on the back surface 26 of the transparent plate portion 28 for displaying the images through the transparent plate portion 28. After the plate 16 displays the images projected by the projector 18, the user could use the touch object 36 to perform a touch operation (e.g. selecting a function icon or moving a cursor) on the touch surface 24. During the aforesaid process, via the aforesaid touch positioning design of the optical touch module 20, the host 22 could perform the touch operation of the touch object 36 on the touch surface 24 accordingly, so as to complete the projective touch operation of the projective touch apparatus 10.

On the other hand, if the user wants to contain the projector 18, the user just needs to push the platform 14 to slide inwardly along the rail structure 13 relative to the rail base 12, so as to make the projector 18 move with sliding of the platform 14 from the projecting position as shown in FIG. 2 to the containing position as shown in FIG. 4. Accordingly, the projector 18 could be contained on the rail base 12 to complete the projector containing operation of the projective touch apparatus 10, so that the user could move the projective touch apparatus 10 conveniently.

It should be mentioned that disposal of the projector is not limited to the aforesaid embodiment, meaning that the present invention could also adopt the front projection design. For example, in another embodiment, the plate could be an opaque plate and the platform and the projector could be slidably disposed on the rail base and located in front of the plate. Accordingly, when the projector moves with sliding of the platform to a projecting position in front of the plate, the projector could project images to the touch surface of the plate for displaying the images on the plate. Furthermore, the support frame portion mentioned in the aforesaid embodiment could be an omissible component for simplifying the structural design of the plate and achieving the frameless purpose so as to further reduce the overall weight of the plate.

Compared with the prior art utilizing a hanging arm to hang a projector above a plate, the present invention adopts the design in which a projector is disposed under a plate and could move with sliding of a platform, so as to achieve the purpose that the projector could selectively move to a projecting position for projecting images to the plate or to a containing position for being contained on a rail base. In such a manner, the present invention could reduce the mounting height of the projector for efficiently solving the image shaking problem aforementioned in the prior art, so as to greatly improve the touch accuracy of the projective touch apparatus and the viewing comfort of the images projected by the projector. Furthermore, since the present invention could further reduce the overall volume of the projective touch apparatus as mentioned above, the user could set up or move the projective touch apparatus conveniently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projective touch apparatus comprising:
a rail base having a rail structure;
a plate standing vertically on the rail base and having a touch surface and a back surface opposite to the touch surface;
an optical touch module disposed on the plate for positioning a touch position of at least one touch object on the touch surface;
a platform slidably disposed through the rail structure;
a projector disposed on the platform and located under the plate for moving with sliding of the platform along the rail structure to a projecting position to project an image to the touch surface or a back surface of the plate, or to a containing position to be contained on the rail base; and
a host disposed in the rail base and electrically connected to the projector and the optical touch module for controlling the projector to project the image and for performing a touch operation of the at least one touch object on the touch surface according to the touch position of the at least one touch object and the image.

2. The projective touch apparatus of claim 1, wherein the at least one touch object has a reflection end portion, and the optical touch module comprises:
at least two optical devices, each optical device comprising:
a light emitting unit for emitting light toward the touch surface; and
an image capturing unit disposed at a position corresponding to a corner of the touch surface and located under the light emitting unit for capturing a touch image toward the touch surface; and
a control circuit board electrically connected to the at least two optical devices and the host, for controlling the at least two optical devices and for positioning the touch position of the at least one touch object on the touch surface according to a reflection position of the reflection end portion of the at least one touch object in the touch image captured by each image capturing unit.

3. The projective touch apparatus of claim 2, wherein the light emitting unit is an infrared light emitting diode.

4. The projective touch apparatus of claim 1, wherein the plate has a transparent plate portion and a projection film, the projection film is attached to the back surface of the transparent plate portion, and when the projector moves with sliding of the platform along the rail structure to the projecting position so as to be located behind the plate, the projector projects the image to the projection film for displaying the image through the transparent plate portion.

5. The projective touch apparatus of claim 4, wherein the transparent plate portion is made of transparent tempered glass material.

6. The projective touch apparatus of claim 4, wherein the plate further has a support frame portion, and the support frame portion is disposed around the transparent plate portion and fixed to the rail base so as to make the transparent plate portion stand vertically on the rail base.

7. The projective touch apparatus of claim 6, wherein the optical touch module is disposed on the support frame portion.

8. The projective touch apparatus of claim 1, wherein the plate is an opaque plate, and when the projector moves with sliding of the platform along the rail structure to the projecting position so as to be located in front of the plate, the projector projects the image to the touch surface of the plate.

9. The projective touch apparatus of claim 1, wherein the projector is a short-throw projector.

10. The projective touch apparatus of claim 1 further comprising:
a plurality of wheels disposed under the rail base.
